(19) United States
(12) Patent Application Publication
(10) Pub. No.: US 2015/0134939 A1
(43) Pub. Date: May 14, 2015

(54) INFORMATION PROCESSING SYSTEM, INFORMATION PROCESSING METHOD AND MEMORY SYSTEM

(71) Applicant: Shanghai XinHao Micro Electronics Co. Ltd., Shanghai (CN)

(72) Inventor: Chenghao Kenneth Lin, Shanghai (CN)

(21) Appl. No.: 14/410,060

(22) PCT Filed: Jun. 14, 2013
(86) PCT No.: PCT/CN2013/077215

§ 371 Date: Dec. 19, 2014

(30) Foreign Application Priority Data
Jun. 15, 2012 (CN) 201210199679.2

(51) Int. Cl. G06F 9/30

(52) U.S. Cl. CPC G06F 9/30058; G06F 9/30145
USPC 712/234

(57) ABSTRACT

An information processing system is provided. The information processing system includes a processor used to obtain information, a memory used to store the information and output an information block based on a received address; and a scanner used to generate an address based on the current information block and to provide the address to the memory, where the current information block is the information block currently outputted from the memory. Thus, the speed for obtaining the information block by the processor (information block requested device) is further improved, and the execution speed of the processor and the information processing system is improved.

### TECHNICAL FIELD

The present invention generally relates to computer architecture technologies and, more particularly, to an information processing system, an information processing method and a memory system.

### BACKGROUND ART

In modern processor architecture, a processor core is a core device. The processor may be General Processor, central processor unit (CPU), Microprogrammed Control Unit (MCU), Digital Signal Processor (DSP), Graphics Processing Unit (GPU), System on Chip (SOC), Application Specific Integrated Circuit (ASIC), and so on. All kinds of computation tasks may be solved by running the processor. Typically, during the processor runs, a large number of instructions and data need to be read and executed. As used herein, instructions and data are called information. Thus, a memory is required to store the information.

### DISCLOSURE OF INVENTION

### Technical Problem

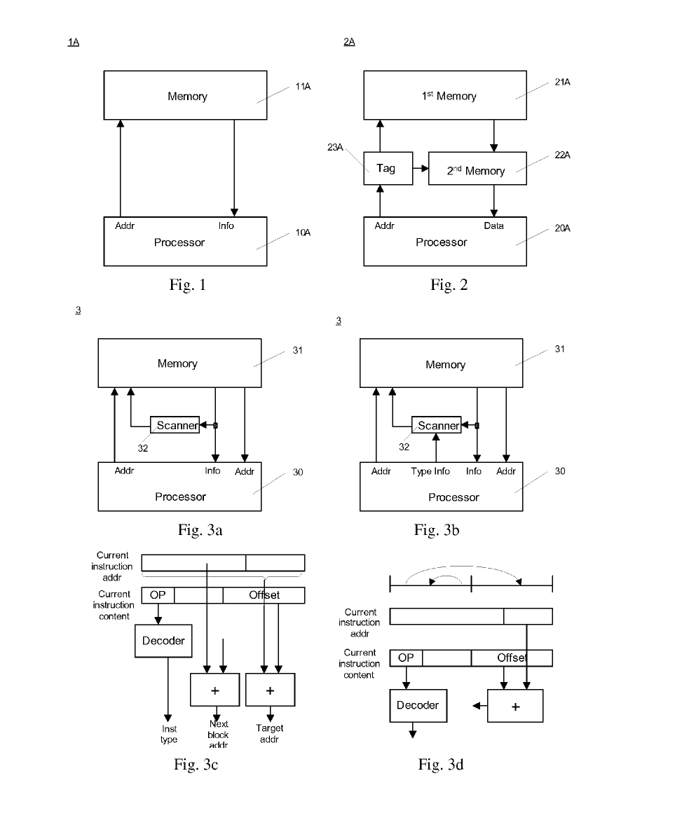

Referring to FIG. 1, FIG. 1 illustrates a block schematic structural diagram of an existing information processing system. As shown in FIG. 1, the information processing system 1A includes: a processor 10A and a memory 11A; when the processor 10A needs information, the processor 10A sends an address to the memory 11A, and the memory 11A provides an information block for the processor 10A based on the received address. Although information request from the processor 10A can be met by using this method, as the speed of the processor is much faster than the speed of the memory, the execution speed of the processor may be reduced due to the requested information is not provided promptly.

Another information processing system is proposed in prior art. Referring to FIG. 2, FIG. 2 illustrates a block schematic structural diagram of another existing information processing system. As shown in FIG. 2, the information processing system 2A includes a processor 20A, a first memory 21A, a second memory 22A and a tag 23A, wherein the first memory 21A and the second memory 22A are used to store an information block, and the tag 23A is used to record the information block address stored in the second memory 22A.

In the information processing system 2A, the speed of the second memory 22A is faster than the speed of the first memory 21A, which can better match the speed of the processor 20A. However, as the capacity of the second memory 22A is smaller than the first memory 21A, the second memory 22A can only store part of the information from the first memory 21A. Thus, when the information block needed by the processor 20A is stored in the second memory 22A, the entire information processing system 2A has a fast execution speed. When the information block needed by the processor 20A is not stored in the second memory 22A, the processor 20A need to load these information blocks from the first memory 21A, thereby greatly reducing the execution speed of the information processing system and the processor.

For prior art, how to solve this problem becomes key point of technological development.

### Solution to Problem

### Technical Solution

One aspect of the present disclosure includes an information processing system. The information processing system includes a processor used to obtain information, a memory used to store the information and output an information block based on a received address; and a scanner used to generate an address based on the current information block and to provide the address to the memory, where the current information block is the information block currently outputted from the memory.

Another aspect of the present disclosure includes an information processing method for an information processing system, which includes at least a processor, a memory, and a scanner. The information processing method includes the processor sending an address, the memory outputting an information block based on the address sent from the processor, the scanner generating an address based on the current information block outputted from the memory and providing the generated address to the memory, and the memory outputting the information block based on the address provided by the scanner.

Other aspects of the present disclosure can be understood by those skilled in the art in light of the description, the claims, and the drawings of the present disclosure.

### Advantageous Effects of Invention

### Advantageous Effects

The disclosed systems and methods may provide better performance than the prior art. In the information processing system, the processor can obtain a plurality of information blocks from a request/address, improving the rate for obtaining information blocks. Obviously, it improves the execution speed of the processor, i.e., it improves the information processing speed of the processor.

### BRIEF DESCRIPTION OF DRAWINGS

### Description of Drawings

FIG. 1 illustrates a block schematic structural diagram of an existing information processing system in the prior art;

FIG. 2 illustrates a block schematic structural diagram of another existing information processing system in the prior art;

FIGS. 3a˜3b illustrate block schematic structural diagrams of the information processing system consistent with the disclosed embodiment 1;

FIG. 3c illustrates a schematic diagram for generating an address by a scanner consistent with the disclosed embodiment 1;

FIG. 3d illustrates a schematic diagram for implementing a filtering function of a scanner consistent with the disclosed embodiment 1;

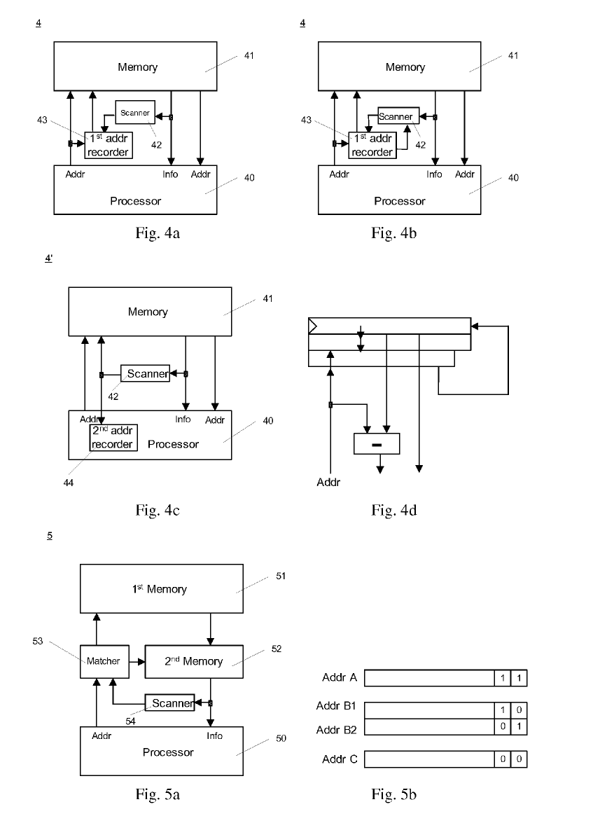

FIGS. 4a˜4c illustrate a block schematic structural diagram of the information processing system consistent with the disclosed embodiment 2;

FIG. 4d illustrates a schematic diagram of the implementation of the first address recorder consistent with the disclosed embodiment 2;

FIG. 5a illustrates a block schematic structural diagram of the information processing system consistent with the disclosed embodiment 3;

FIGS. 5b˜5d illustrate a diagram of the storage and replacement of information blocks in the information processing system consistent with the disclosed embodiment 3;

FIG. 6 illustrates a block schematic structural diagram of the information processing system consistent with the disclosed embodiment 4;

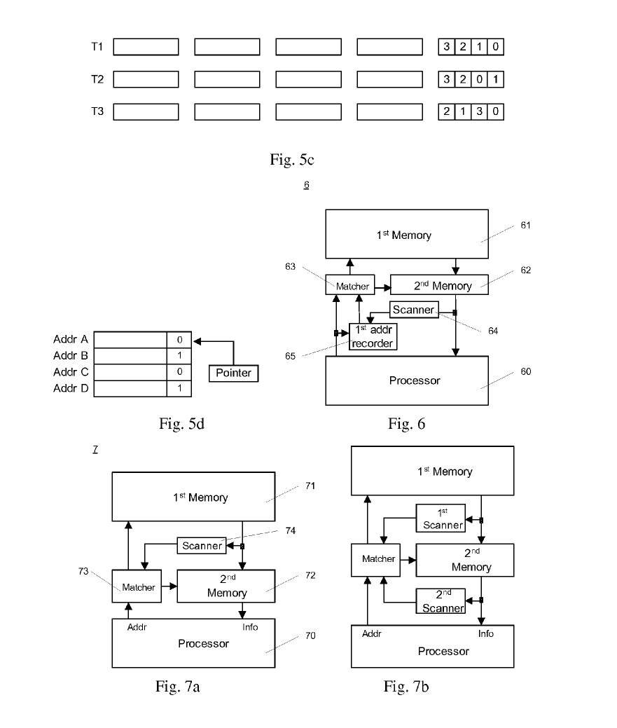

FIGS. 7a˜7b illustrate a block schematic structural diagram of the information processing system consistent with the disclosed embodiment 5;

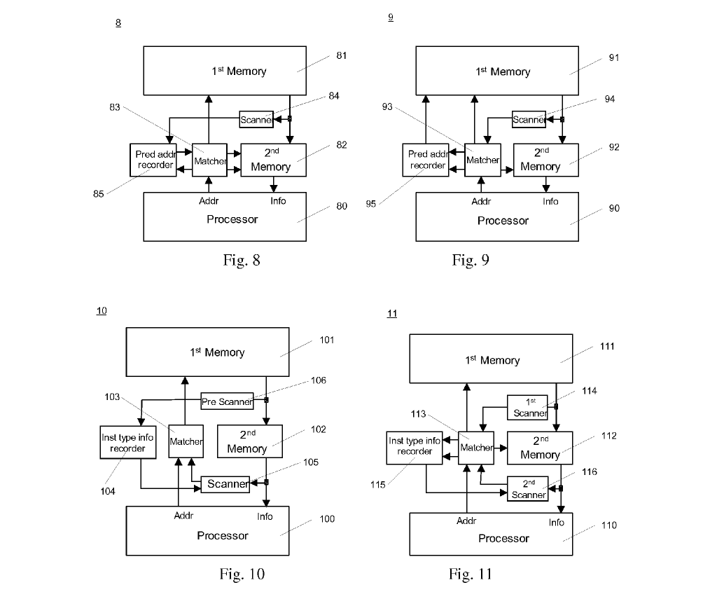

FIG. 8 illustrates a block schematic structural diagram of the information processing system consistent with the disclosed embodiment 6;

FIG. 9 illustrates a block schematic structural diagram of the information processing system consistent with the disclosed embodiment 7;

FIG. 10 illustrates a block schematic structural diagram of the information processing system consistent with the disclosed embodiment 8;

FIG. 11 illustrates a block schematic structural diagram of the information processing system consistent with the disclosed embodiment 9;

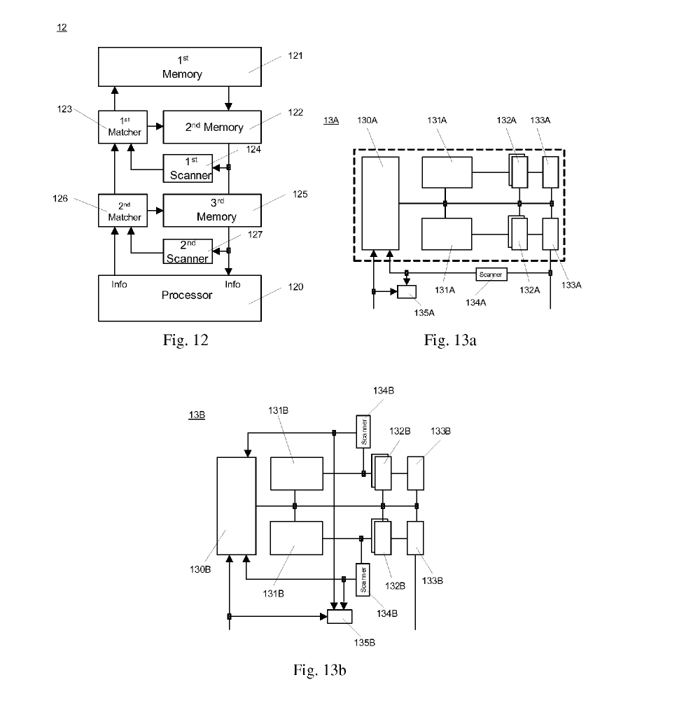

FIG. 12 illustrates a block schematic structural diagram of the information processing system consistent with the disclosed embodiment 10; and

FIGS. 13a˜13b illustrate a block schematic structural diagram of the information processing system consistent with the disclosed embodiment 11.

### BEST MODE FOR CARRYING OUT THE INVENTION

### Best Mode

FIG. 3a illustrates an exemplary preferred embodiment(s).

### Mode for the Invention

### Mode for Invention

Reference will now be made in detail to exemplary embodiments of the invention, which are illustrated in the accompanying drawings. The same reference numbers may be used throughout the drawings to refer to the same or like parts.

### Embodiment 1

Referring to FIG. 3a, FIG. 3a illustrates a block schematic structural diagram of the information processing system consistent with the disclosed embodiment 1. As shown in FIG. 3a, the information processing system 3 comprises:

A processor 30, used to obtain information;

A memory 31, used to store information and output information block based on a received address; and

A scanner 32, used to provide the address for the memory based on the address generated from the current information block, and the current information block is the information block currently outputted from the memory 31.

In this case, the information processing system 3 processes the information by the following method:

Step A: the processor 30 sends the address;

Step B: the memory 31 outputs the information block based on the address outputted from the processor 30;

Step C: the scanner 32 generates the address based on the information block currently outputted from the memory 31 and provides the address to the memory 31;

Step D: the memory 31 outputs the information block based on the address provided by the scanner 32.

That is, in the present embodiment, when the processor 30 sends an information request address (i.e., send a request/request address), the memory 31, in addition to output an information block based on the address sent by the processor 30, also sends another or a plurality of information blocks based on the addresses generated by the scanner 32, i.e., the memory 31 may provide a plurality of information blocks.

When an existing processor sends an information request address, the memory sends an information block based on the address. Thus, the processor can only obtain an information block corresponding to the address (or the information block pointed to by the address). In the information processing system of the present embodiment, the processor 30 sends an information request address; the memory 31 outputs (sends out/sends/provides) a plurality of information blocks (one information block is sent from the request/address of the processor 30; the remaining information blocks are sent from the request/address of the scanner 32). Therefore, the processor 30 can obtain a plurality of information blocks from a request/address, improving the rate for obtaining information blocks. Obviously, it improves the execution speed of the processor 30, i.e., it improves the information processing speed of the processor 30.

It should be noted that, in the terminology of the present invention, the information block is the unit of information, which includes an instruction block containing instructions and a data block containing data. As used herein, the capacity of the information block is not specified (i.e., the number of bits) and may be defined according to different system requirements.

In addition, in the present embodiment, the processor may be General Processor, Central Processor Unit (CPU), Microprogrammed Control Unit (MCU), Digital Signal Processor (DSP), Graphics Processing Unit (GPU), System on Chip (SOC), Application Specific Integrated Circuit (ASIC), and so on; the memory 31 may be register, register file, static memory (SRAM), dynamic memory (DRAM), flash memory, hard disk, solid state disks (SSD), and so on. The devices are not limited in the present application.

In the present embodiment, the scanner 32 may generate address by a variety of ways as follows:

Method 1

When the scanner 32 parses the current information block, if it is judged that the current information block contains a branch instruction, the address of the branch instruction is obtained, generating an address.

Specifically, the scanner 32 parses the current information block by the following process: the scanner 32 serves the current information block as an instruction block and obtains the OP (instruction type information, labeling instructions for a branch instruction or a non-branch instruction) of the instruction block, further obtaining whether the instruction block contains a branch instruction. In this case, it should be noted that the instruction block may comprise one instruction or a plurality of instructions. When the instruction block includes multiple instructions, if some or all of the instructions are branch instructions, the instruction block may include a plurality of branch instructions.

If it is judged (or obtained by the parsing process) that the current information block contains a branch instruction, the address of the branch instruction is obtained. As used herein, the target address of the obtained branch instruction address generates an address. That is, the address of the obtained branch instruction is provided for the memory 31; and the memory 31 outputs the information block based on the branch instruction address. As used herein, the information block is the instruction block.

Method 2

The scanner 32 may obtain the address of the current information block and add an offset to the address of the current information block to generate the address. As used herein, the offset is a fixed value. Preferably, the offset is an address offset of two adjacent instruction blocks. Thus, the address generated by the scanner 32 is the address of the information block adjacent to the current information block, particularly the information block whose address is next to the current information block.

Method 3

As used herein, Method 3 is a combination of Method 1 and Method 2, i.e., the address generated by the scanner 32 comprises: when the scanner 32 parses the current information block, if it is judged that the current information block contains a branch instruction, the address of the branch instruction is obtained to generate an address (where the term “an” refers to one, some or part); the scanner 32 obtains the address of the current information block and adds an offset to the address of the current information block to generate another address.

Next, specific implementations of the scanner that generate the address are provided.

FIG. 3C illustrates an exemplary scanner consistent with the disclosed embodiments. As shown in FIG. 3C, the scanner may generate the address by the following ways:

1. the scanner through the decoder judges whether the current information block is a branch instruction or a non-branch instruction; if the current information block is a branch instruction, the current instruction address adds the offset of the branch instruction by an adder to obtain the target address of the branch instruction, thereby generating the address;

2. the scanner adds a block offset (i.e. the address offset of two adjacent information blocks) to the address of the current information block through an adder to obtain the address of the information block adjacent to the current information block.

Of course, the scanner only uses its part function if the method 1 or method 2 is used.

Method 4

The Method 4 is the improvement of the Method 1. After addresses are generated by method 1, the scanner 32 also filters the generated addresses. The addresses provided for the memory 31 are the addresses filtered by the scanner 32. The scanner 32 filters the generated addresses by the following method:

it is judged whether the information block pointed to by the address generated from the method 1 is the current information block; if it is not the current information block, the generated address passes the filtering process.

As used herein, the address generated by the method 1 is probably the address of the current information block, i.e., the information block just outputted by the memory 31. In this case, if the scanner 32 still provides the address (also called duplicate address, i.e., the current information block address) for the memory 31; the request rate of the effective address is reduced (as used herein, the effective address refers to the remaining address, that is, the address generated from the method 1 which is different from the address of the current information block), i.e., the rate for sending the information blocks from the memory 31 is reduced based on the effective address. Accordingly, duplicate addresses are removed in the method 4 and are not provided for the memory 31. Thus, the speed for sending valid information blocks (the information block corresponding to the effective address) from the memory 31 can be improved. Further, the speed for obtaining the valid information blocks by the processor 30 is improved, and the execution speed of the processor 30 is improved.

Method 5

The Method 5 is the improvement of the Method 3. The purpose and principles of the Method 5 are the same as the Method 4. In the Method 5, first, the scanner 32 provides some of the addresses generated from the Method 3 (referring to the Method 3, including the address generated by Method 1 and the address generated by Method 2) for the memory 31. The address generated by the Method 2 is the address that passes the filtering process, i.e., the scanner 32 provides the address generated by the Method 2 to the memory 31. It means that the memory 31 will certainly output the information block pointed to by the address generated by the Method 2. The Method 5 expands the comparison range of the address generated by the Method 1. The address compares to the address of the current information block in the Method 4 as well as the address of the information block pointed to by the address generated by the Method 2. If the address is not within the scope of both comparison results, the address passes the comparison process or the filtering process and is provided for the memory 31. The memory 31 outputs the information block based on the input address.

Next, for the Method 4 and the Method 5, some key points are explained. These key points that are the common sense of the field are described in the following for better understanding purpose:

First, the information block is the unit of information, but not the smallest unit of information, including units of information (or a unit of information). The information block is a collection of one or more units of information. Similarly, the instruction block is a collection of one or more instructions; and the data block is a collection of one or more units of data.

Second, the information block address refers to the address of the entire information block; the information block address also refers to the address of the first unit of information in the information block. Based on the address of the information block, the address of every unit of information may be obtained. Similarly, the address of a/a plurality of information in the information block is obtained and the information block pointed to by the obtained address is the same information block.

Based on the above two key points, the method 4 and the method 5 are provided in the present application. First of all, because the address of a/multiple units of information obtained by the scanner 32 probably points to the same information block, this case is excluded in the method 4 and the method 5, thereby enhancing rate/efficiency of valid blocks outputted by the memory 31.

The method for determining whether the address of the information entry points to the same information block may be varied. The present application does not limit how to determine that the address of the information entry points to the same information block. As used herein, an exemplary method is provided.

When the address of an instruction block is obtained, each instruction address in the instruction block and the length of the instruction block (i.e., the address deviation between the first instruction and the last instruction) may be easily obtained. Whether the address of the information entry (as used herein, that is, the generated address, or further refers to the address to be compared in the method 4 and method 5) points to the information block to be compared (the current information block in the method 4; the current information block in the method 5 and the information block pointed to by the address obtained by the method 2) is determined by whether the offset in the information entry locates within the length of the information block or whether the address of the information entry is the address of the information entry in the information block to be compared. It is understood that the disclosed judgment method is for illustrative purposes and not limiting, other judgment methods may be omitted.

Next, specific implementations of the scanner that generates the addresses by the above methods are provided, especially for the method 4 and the method 5. The method 4 and the method 5 is the further processing of the method 1 and the method 2, respectively. Therefore, specific implementations of the following scanner are the further improvement based on FIG. 3c.

As shown in FIG. 3d, the scanner performs a filtering operation by the following method:

The scanner adds the offset in the block of the current instruction (i.e., the address offset of the current instruction address corresponding to the block containing the current instruction) to the branch offset of the branch instruction by an adder to obtain a total offset. Base on the total offset, it is judged whether the target address of the branch instruction points to the current information block or the next information block of the current information block, thus filtering the generated address.

Method 6

In the Method 6, the scanner 32 firstly obtains type information of the current information block, and the type information describes whether the information block is an instruction block or a data block. The time that the scanner 32 obtains the current information block type is the time of executing step C, or before executing step C. In the Method 6, the type information of the current information block is provided for the scanner 32 by the processor 30, referring to FIG. 3b. Typically, when the processor 30 sends/outputs an address to the memory 31, the processor 30 also sends the type information of the information block pointed to by the requested address to the scanner 32 (i.e., the two steps are performed simultaneously in step A). It should be noted that the processor 30 has information about whether the requested information block is an instruction block or a data block. Therefore, no additional step is needed for obtaining the type information of the current information block. The only step needed is that the processor 30 sends the information (type information of the current block) to the scanner 32.

In the Method 6, first, the scanner 32 obtains the type information of the current information block. When the current information block is a data block, an address may not be generated. Because the address generated by the data block is an interference address, the rate/efficiency for generating the effective address is increased by excluding this type of address (in this case, the effective address refers to the instruction address. Although the effective address is slightly different with the effective address described in the method 4, the effective address is distinguished from the previous described duplicate addresses or the interference invalid address. The present disclosure can be understood by those skilled in the art in light of the description, the claims, and the drawings of the present disclosure.); and the effective address is provided for the memory 31. Thus, the speed for sending the valid block (the information block corresponding to the effective address) from the memory 31 can be improved. Further, the speed for obtaining the valid information block by the processor 30 is improved, and the execution speed of the processor 30 is improved.

Further, in the present embodiment, when the memory 31 sends the information block, the memory 31 also sends the address corresponding to the information block at the same time. Thus, the processor 30 may determine whether to receive the information block by judging whether the information block is needed. The memory 31 may output the information block and the address corresponding to the information block at the same time only for the request/the address sent by the scanner 32 and the address is only sent in step D. The memory 31 may also output the information block and the address corresponding to the information block at the same time for the request/the address sent by the processor 30 or the scanner 32, i.e. in step B and step D, both the information block and the address are outputted at the same time. Of course, in other embodiments of the present invention, when the memory 31 sends the information block, it may not send the address corresponding to the information block at the same time.

Further, in other embodiments of the present invention, the address corresponding to the information block may not be sent by the memory 31 at the time when the information block is sent. The address corresponding to the information block is sent to the processor 30 by the scanner 32, which is not limited in the application.

Further, in the present embodiment and the subsequent embodiments, the processor may set a port for receiving the address; the processor may set a port for outputting the information block type; the port for outputting the information block type is a pin or a bus output port; the information transmitted on the bus may be the command word representing the information block type; the memory may set the port for outputting the address; the scanner may set a port for receiving the information block type.

### Embodiment 2

Referring to FIG. 4a, FIG. 4a illustrates a block schematic structural diagram of the information processing system consistent with the disclosed embodiment 2. As shown in FIG. 4a, the information processing system 4 includes:

A processor 40, used to obtain information;

A memory 41, used to store information and output information block based on a received address;

A scanner 42, used to provide the address for the memory based on the address generated from the current information block, and the current information block is the information block currently sent from the memory 41.

A first address recorder 43, used to record n most recent addresses outputted by the processor 40, wherein n is a natural number.

Accordingly, the information processing method using the information processing system 4 is as follows:

Step A: the processor 40 sends the address;

Step B1: the first address recorder 43 records the address sent by the processor 40;

Step B2: the memory 41 outputs the information block based on the address sent by the processor 40;

Step C: the scanner 42 generates the address based on the information block currently outputted from the memory 41 and determines whether the address is recorded in the first address recorder. If not, the address is provided for the memory 41;

Step D: the memory 41 outputs the information block based on the address provided by the scanner 42.

The information processing system may perform the step B1 first and then perform the step B2 or vice versa; or the information processing system simultaneously performs the step B1 and the step B2, which shall not be limited in the present application.

The difference between the embodiment 1 and the embodiment 2 is that the present embodiment 2 further comprises a first address recorder 43. How to further improve the performance of the information processing system by the first address recorder 43 is described below. The content that is not described in the present embodiment 2 refers to the embodiment 1.

The first address recorder 43 is used to record n most recent addresses outputted by the processor 40 in the present embodiment. In general, the processor 40 stores the information blocks pointed to by the recently outputted addresses. Thus, in the present embodiment 2, when the scanner 42 provides the address for the memory 41, the recently outputted addresses are removed, increasing the effective addresses of the addresses provided by the scanner 42. Thus, the speed for sending the valid block (the information blocks corresponding to the effective addresses) by the memory 41 can be improved. Further, the speed for obtaining the valid information block by the processor 40 is improved, and the execution speed of the processor 40 is improved.

Further, referring to FIG. 4b, in the present embodiment 2, the scanner 42 obtains the step length of the address based on the address provided for the memory 41 and the address recorded by the first address recorder 43; the scanner 42 generates an address by adding the step length of the address to the address provided for the memory 41.

In general, there exists a certain rule when the processor 40 obtains the data block, that is, the processor 40 always obtains the data block having p address offsets, and wherein p is an integer other than zero, i.e., the p value may be a positive integer or a negative integer. When the p value is a positive integer, the rule is that the processor 40 obtains the subsequent p data blocks of the current data block; when the p value is a negative integer, the rule is that the processor 40 obtains the front −p data blocks of the current data block.

Accordingly, in the present embodiment, the system performs a fuzzy matching operation between the address provided by the scanner 42 for the memory 41 and the address recorded by the address recorder 43, i.e. the low q bits of the two addresses are not compared during the matching operation, wherein q is a natural number; preferably the value of q is from 4 to 10, for example, the value of q is 4, 6, 8 or 10. The step length of the address may be obtained if the fuzzy matching operation is successful. For example, when the value of q is 6 (the unit of q is bit), the step length of the address may be obtained if the fuzzy matching operation is successful and the step length of the address is between (−25) and (25−1). Whether the value is positive or negative may be obtained during the fuzzy matching operation. Preferably, the first address recorder 43 selects a memory having a first-in first-out function to implement the device. Once the fuzzy matching operation between the address provided for the memory 41 and the address recorded by the address recorder 43 is successful, the fuzzy matching operation for providing the address for the memory 41 ends. Then, the address provided for the memory 41 which is matched successfully in the fuzzy matching operation adds the step length of the address to generate an address. It should be noted that when this generated address is provided for the memory 41, one of the 6 methods described in the embodiment 1 may be selected (from the method 1 to the method 6) to provide the generated address for the memory 41 and/or to confirm by the first address recorder 43. The skilled in the art may implement a variety of deformation on the basis of the present application discloses.

Next, specific implementations of the first address recorder are provided:

As shown in FIG. 4d, when the system needs to determine whether the first address recorder records the address generated by the scanner, the system may compare the address generated by the scanner with the address recorded by the first address recorder (as used herein, the comparison operation may be implemented by a subtractor). If the comparison result is the same, it means hit, that is, the first address recorder records the address generated by the scanner;

When the system needs to obtain a step length of the address, a part of the address (the low q bits are not usually compared) generated by the scanner is compared with the address recorded by the first address recorder. After the comparison result of the part of the address is the same, the part of the address that is not compared, the lower q bits, performs a subtract operation by a subtractor. The difference is the step length of the address, obtaining the step length of the address by the operation.

In the present embodiment 2, an information processing system 4′ is provided. The difference between the information processing system 4′ and the information processing system 4 is that a second address recorder 44 replaces the first address recorder 43, wherein the second address recorder 44 is used to record the addresses of m information blocks stored in the memory 40, and m is a natural number.

In the present embodiment 2, the purpose of using the address recorder (including the first address recorder 43 and the second address recorder 44) is to obtain information about the information blocks stored in the processor 40. Therefore, the addresses pointing to these information blocks are not provided for the memory 41 by the scanner 42. The speed that the memory 41 transmits the valid information block is increased. The speed for obtaining valid information block by the processor 40 is further improved, and the execution speed of the processor 40 is improved.

Wherein, in the information processing system 4, the information about information blocks stored in the processor 40 may be obtained by recording n most recent addresses outputted by the processor 40. The filtering process is not entirely accurate. In the information processing system 4′, the addresses of the m information blocks stored in the processor 40 can be directly recorded in the second address recorder. Thus, the information blocks stored in the processor 40 may be accurately obtained, improving the accuracy of the filter operation. Further, the speed for obtaining the valid information block by the processor 40 is improved, and the execution speed of the processor 40 is improved.

Specifically, the method using the second address recorder 44 is similar to the method using the first address recorder 43. The description is not repeated in the present application. It should be noted, because the second address recorder 44 needs to accurately obtain the addresses of the m information blocks stored in the processor 40, preferably, the second address recorder 44 is an address match part of a cache in the processor 40, e.g., tag.

### Embodiment 3

Referring to FIG. 5a, FIG. 5a illustrates a block schematic structural diagram of the information processing system consistent with the disclosed embodiment 3. As shown in FIG. 5a, the information processing system 5 includes:

A processor 50, used to obtain information;

A first memory 51, used to store the information and output information block based on a received address;

A second memory 52, used to store the information and output information block based on a received address;

A matching unit 53, used to record addresses of the information blocks stored in the second memory 52;

A scanner 54, used to generate an address based on the current information block and provide the address for the first memory 51 by the matching unit 53, and the current information block is the information block currently sent from the second memory 52.

Accordingly, the information processing method using the information processing system 5 is as follows:

Step A: the processor 50 sends the address;

Step B: the matching unit 53 receives the address sent by the processor 50; if the received address matches one of the addresses stored in the matching unit 53, the second memory 52 outputs information block based on the address; if the received address does not match any of the addresses stored in the matching unit 53, the first memory 51 outputs the information block to the second memory 52 based on the address, and the second memory 52 stores and outputs the information block to the processor 50;

Step C: the scanner 54 generates the address based on the information block currently outputted from the second memory 52 and provides the address for the matching unit 53. If the address is not in the matching unit 53, the address is provided for the first memory 51;

Step D: when the address provided by the scanner 54 is not in the matching unit 53, the first memory 51 outputs the information block to the second memory 52 based on the address, and the second memory 52 stores the information block.

The difference between the embodiment 3 and the embodiment 1 is that a plurality of memory devices is used in the present embodiment 3. Specifically, two memory devices are used here, that is, the first memory 51 and the second memory 52, respectively. At the same time, the matching unit 53 is also correspondingly set for the second memory 52. For signal transmission, the second memory 52 is closer to the processor 50 than the first memory 51, i.e., while an information block is outputted at the same time, the information block outputted by the second memory 52 reaches the processor 50 earlier than the information block outputted by the first memory 51. Next, performance improvement by using a plurality of memory devices and working method of the information processing system for a plurality of memory devices are introduced. The omitted content in the embodiment 3 may refer to the embodiment 1.

In general, the second memory 52 and the first memory 51 may be selected without distinction, i.e., the memory with same property may be selected as the second memory 52 and the first memory 51. Preferably, the memory with the optimum performance is selected as the second memory 52, i.e., preferably faster memory is selected as the second memory 52; poor performance memory is selected as the first memory 51. At the same time, it is well known, in the prior art, when the memory has better performance/faster speed, the capacity of the memory is smaller, i.e. the capacity of the memory with better performance/faster speed is smaller. Accordingly, it is specifically described in the present embodiment 3 that the second memory 52 has better performance but smaller capacity compared to the first memory 51, Other situations also refer to such case. The description is not repeated in the application.

First, the information processing system 5 provided by the present embodiment 3 has obvious advantages. As an additional memory is added compare to the embodiment 1 and the embodiment 2, the speed for outputting the information blocks by the memory is increased. Further, the speed for obtaining the information blocks by the processor is improved, and the execution speed of the processor is improved. This key point may explain the significance of the cache (referring to FIG. 2 and the background art described in FIG. 2) in the prior art.

In the present embodiment 3, the scanner 54 generates the address and the address is provided for the first memory 51 by the matching unit 53 after performing a matching operation. Compared to the information processing system 2 shown in FIG. 2, the speed for outputting the information block by the memory is improved. The speed for obtaining the information block by the processor is further improved, and the execution speed of the processor is improved.

From viewpoint of the speed, in a preferably selected case, the capacity of the memory is usually restricted, for example, the capacity of the second memory 52. Thus, in the following description of the present embodiment 3, several replacement policies for the information blocks stored in the second memory 52 are provided to solve the capacity problem of the second memory 52 through the efficient and reliable replacement of the stored information blocks.

Method 1

The capacity of the information blocks stored in the memory (including the first memory 51 and the second memory 52) is multiple times more than the capacity of the information block read by the processor 50. As used herein, the multiple times refer twice.

Referring to FIG. 5b, in the method 1, the lower two bits of the memory address is used as a tag bit.

At the beginning, as shown in address A, the second memory 52 obtains and stores information block from the first memory 51. At this time, the lower two bits of the memory address are set to ‘1’;

Next, as shown in address B, the information block stored in the second memory 52 is read by the processor 50. Since the capacity of the information block stored in the second memory 52 is double the capacity of the information block read by the processor 50, only half of the information blocks stored in the second memory 52 are read by the processor 50 during each read operation. Then, the tag position corresponding to the information blocks read by the processor 50 is ‘0’. At this time, the address B1 or the address B2 may occur.

Finally, when the processor 50 reads (the read operation occurs after reading a times address B, wherein a is non-negative integer) the other half of the information blocks stored in the memory address (the other half of the information blocks for the memory; the other information block for the processor), the lower two bits of the memory address are set to ‘0’ (as shown in address C). At this time, the memory address and its corresponding memory space can be used to store the subsequent information blocks, that is, the information blocks in the second memory 52 that are obtained from the first memory 51.

Method 2

The second memory 52 is a way set associative memory. As used herein, the way set associative is a four-way set.

Referring to FIG. 5c (In FIG. 5c, the tag bits of the four-way set memory address are used as the four sets together, as used herein, it is assumed that the tag bits of the memory address is from right to left showing the first way set, the second way set, the third way set and the fourth way set in turn), in the method 2, when storing the information block:

When the information block is being stored in the first way set of the 4-way set memory, the corresponding tag bit of its memory address is set to the maximum value ‘3’. At this time, if the information block has not been stored in the other 3 way sets, the corresponding tag bits are set to the minimum value ‘0’.

Subsequently, when the information block is being stored in the second way set of the 4-way set memory, the corresponding tag bit of its memory address is set to the maximum value ‘3’. At the same time, the tag bit previously stored the memory address subtracts ‘1’, that is, the tag bit of the memory address of the first way set is set to ‘2’. In addition, if the information block has not been stored in the remaining 2 way sets, the corresponding tag bits are still the minimum value ‘0’.

And so forth, when the information block is being stored in the third way set of the 4-way set memory, the corresponding tag bit of its memory address is set to the maximum value ‘3’. At the same time, the tag bit previously stored in the memory address subtracts ‘1’, that is, the tag bit of the memory address of the first way set is set to ‘1’, and the tag bit of the memory address of the second way set is set to ‘2’. In addition, if the information block has not been stored in the fourth way set, the corresponding tag bit is still the minimum value ‘0’.

Finally, when the information block is being stored in the fourth way set of the 4-way set memory, the corresponding tag bit of its memory address is set as the maximum value ‘3’. While the tag bits of the other three sets of the memory address are ‘2’, ‘1’ and ‘0’ respectively, i.e., corresponding to a case represented by T1.

Next, when the information block is read, the corresponding tag bit of the memory address of the set of the information block to be read is set to ‘0’, while those tag bit values that are larger than the tag bit (before the change) add ‘1’, and those tag bit values that are smaller than the tag bit (before the change) are unchanged.

If the information block stored in the second way set is read, the tag bit of the second way set is set to ‘0’. At the same time, the tag value that is smaller than the tag bit (before change) adds ‘1 ’, i.e., the tag bit of the first way set adds ‘1’ and becomes ‘1’, thereby forming a case represented by T2.

Subsequently, when the information block continues to be stored in the four way sets, the information block is stored in the memory space pointed to by the memory address with the tag bit ‘0’. At the same time, the corresponding tag bit in the memory address that currently stores the information block is set to the maximum value ‘3’, and other tag bits in the memory addresses subtract ‘1’.

For example, in the case of T2, when an information block continues to be stored in the four way sets, the information block is stored in the second way set. At the same time, the corresponding tag bit in the memory address of the second way set is set to the maximum value ‘3’, and other tag bits in the memory addresses of other 3 way sets subtract ‘1’, that is, the tag bits in the memory addresses of the fourth way set, the third way set and the second way set become ‘2’, ‘1’ and ‘0’, respectively, forming the case represented by T3.

Of course, subsequently, read and write (store) operations for the information block may continue to be performed, wherein the tag bit of the memory address is changed based on the above disclosed rule, achieving efficient use of the memory space. The skilled in the art may implement a variety of deformations on the basis of the present application discloses. Thus, the description is not repeated in the present application.

Method 3

The second memory 52 is a fully associative memory.

Referring to FIG. 5d, in the method 3, when the memory space pointed to by the memory address stores the information block, the tag bit of the memory address is set to ‘1’, and the tag bit is usually the least significant bit of the memory address. Of course, the tag bit may also be the most significant bit of the memory address or a bit between the least significant bit and the most significant bit. At the same time, the number of bits of the tag bit may be one bit or multiple bits, which is not limited in the present application.

As used herein, a pointer is used to identify the memory address that may store the information block. Specifically, when the memory space pointed to by the memory address stores the information block, the tag bit of the memory address is set to ‘1’; when the memory space pointed to by the memory address does not store the information block or the information block stored in the memory space pointed to by the memory address is read, the tag bit of the memory address is set to ‘0’. The pointer always points to the memory address with the tag bit ‘0’ by the movement of the pointer. When the tag bit of the memory address pointed to by the pointer is ‘1’, the pointer moves; When the tag bit of the memory address pointed to/moved to by the pointer is ‘0’, the pointer stops at the memory address until the tag bit of the memory address becomes ‘1’. As used herein, the pointer may be implemented by a loop counter.

When the second memory 52 needs to store the information block, the information block is stored in the position pointed to by the pointer, that is, the memory space pointed to by the memory address with the tag bit ‘0’. Thus, it achieves efficient use of the memory space.

It should be noted that, in the present embodiment, when the information block is stored, the tag bit of the memory address is set to ‘1’; when the information block is read, the tag bit of the memory address is set to ‘0’. In other embodiments of the present invention, the tag bit of the memory address may also be the opposite set. The present embodiment is only a schematic description of the efficient use of the memory space by the tag bit. Those skilled in the art implement various modifications on the basis of the present application discloses, for example, another method for storing and reading data in the memory may be implemented by combining the method 1 with the method 2. The description of various modifications is not repeated in the present application.

### Embodiment 4

Referring to FIG. 6, FIG. 6 illustrates a block schematic structural diagram of the information processing system consistent with the disclosed embodiment 4. As shown in FIG. 6, in the present embodiment 4, the information processing system 6 includes:

A processor 60, used to obtain information;

A first memory 61, used to store the information and output information block based on a received address;

A second memory 62, used to store the information and output information block based on a received address;

A matching unit 63, used to record addresses of the information blocks stored in the second memory 62;

A scanner 64, used to generate an address based on the current information block and provide the address for the memory, and the current information block is the information block currently sent from the second memory 62.

A first address recorder 65, used to record n most recent times addresses outputted by the processor 60, wherein n is a natural number.

Accordingly, the information processing method using the information processing system 6 is as follows:

Step A: the processor 60 sends the address;

Step B: the matching unit 63 receives the address sent by the processor 60; if the matching unit 63 stores the address, the second memory 62 outputs information block based on the address; if the matching unit 63 does not store the address, the first memory 61 outputs the information block to the second memory 62 based on the address, and the second memory 62 stores and outputs the information block to the processor 60;

Step C: the scanner 64 generates the address based on the information block currently outputted from the second memory 62 and compares the address with the address stored in the first address recorder 65. If the address is not recorded in the first address recorder 65, the address is provided for the first memory 61 by the scanner 64;

Step D: When the address provided by the scanner 64 is not in the matching unit 63, the first memory 61 outputs the information block based on the address.

The difference between the embodiment 4 and the embodiment 3 is that the present embodiment 4 further comprises a first address recorder 65. When the scanner 64 provides the address for the first memory 61, the addresses that have been recorded by the first address recorder 65 are removed, therefore increasing the number of effective address among the addresses provided by the scanner 64. Thus, the speed for sending the valid block (the information blocks corresponding to the effective addresses) by the first memory 61 can be improved. Further, the speed for obtaining the valid information block by the processor 60 is improved, and the execution speed of the processor 60 is improved.

The difference between the embodiment 4 and the embodiment 2 is that a plurality of memory devices are used in the present embodiment. Specifically, two memory devices are used here, the first memory 61 and the second memory 62; and the matching unit 63 is set for the second memory 62. For signal transmission, the second memory 62 is closer to the processor 60 than the first memory 61, i.e., when an information block is outputted from the two memory devices at the same time, the information block outputted by the second memory 62 earlier reaches the processor 60 than the information block outputted by the first memory 61.

The present embodiment 4 combines the advantages of the embodiment 2 and the embodiment 3, further improving the performance of the information processing system The contents that are not mentioned in the present embodiment 4 may refer to the embodiment 2 and the embodiment 3. In addition, working process of the scanner 64 may refer to the embodiment 1. That is, the contents that are not mentioned in the present embodiment 4 may refer to the embodiment 1, the embodiment 2 and the embodiment 3.

In addition, in the present embodiment 4, a second address recorder may replace the first address recorder, referring to the implementation of information processing system and method using the first address recorder in the embodiment 2 and the present embodiment 4. The description of the method is not repeated in the present application.

### Embodiment 5

Referring to FIG. 7a, FIG. 7a illustrates a block schematic structural diagram of the information processing system consistent with the disclosed embodiment 5. As shown in FIG. 7a, the information processing system 7 includes:

A processor 70, used to obtain information;

A first memory 71, used to store the information and output information block based on a received address;

A second memory 72, used to store the information and output information block based on a received address;

A matching unit 73, used to record addresses of the information blocks stored in the second memory 72;

A scanner 74, used to generate an address based on the current information block and provide the address for the first memory 71 by the matching unit 73, and the current information block is the information block currently sent from the first memory 71.

Accordingly, the information processing method using the information processing system 7 is as follows:

Step A: the processor 70 sends the address;

Step B: the matching unit 73 receives the address outputted by the processor 70; if the received address matches one of the addresses stored in the matching unit 73, the second memory 72 outputs information block based on the address; if the received address does not match any of the addresses stored in the matching unit 73, the first memory 71 outputs the information block to the second memory 72 based on the address, and the second memory 72 stores and outputs the information block to the processor 70;

Step C: the scanner 74 generates the address based on the information block currently outputted from the first memory 71 and provides the address for the first memory 71 by the matching unit 73;

Step D: if the address provided by the scanner 74 is not in the matching unit 73, the first memory 71 outputs the information block based on the address.

The difference between the embodiment 5 and the embodiment 3 is that the scanner 74 generates the address based on the information block currently outputted from the first memory 71 in the embodiment 5; while the scanner 54 generates the address based on the information block currently outputted from the second memory 52 in the embodiment 3. Of course, in the present embodiment, the performance selection for the first memory 71 and the second memory 72 as well as signal relationship between the two memory devices and the processor 70 are the same as the embodiment 3. In subsequent embodiments, in general, the performance selection for the first memory 71 and the second memory 72 as well as signal relationship between the two memory devices and the processor 70 are the same as the embodiment 3.

The advantage of the present embodiment is that the information blocks that probably be used by the processor 70 output in advance from the first memory 71 to the second memory 72. Thus, when the processor 70 needs to use the information blocks (the information blocks outputted and stored in advance from the first memory 71 to the second memory 72 based on the address generated by the scanner 74), the processor 70 may obtain these information blocks very quickly. The contents that are not mentioned in the present embodiment 5 may refer to the embodiments that are previously described and are not repeated in the present embodiment 5.

In addition, the present embodiment 5 may also be combined with the embodiment 3. The combined information processing system may include two scanners, wherein one scanner generates an address based on the information block outputted by the first memory and the other scanner generates an address based on the information block outputted by the second memory, thereby increasing the number of addresses generated by the scanners. Referring to FIG. 7b, the description of the information processing system shown in FIG. 7b may refer to the description of the information processing systems shown in FIG. 5a and FIG. 7a, which is not repeated in the present embodiment 7.

### Embodiment 6

Referring to FIG. 8, FIG. 8 illustrates a block schematic structural diagram of the information processing system consistent with the disclosed embodiment 6. As shown in FIG. 8, the information processing system includes:

A processor 80, used to obtain information;

A first memory 81, used to store the information and output information block based on a received address;

A second memory 82, used to store the information and output information block based on a received address;

A matching unit 83, used to record addresses of the information blocks stored in the second memory 82;

A scanner 84, used to generate an address based on the current information block and provide the address, and the current information block is the information block currently sent from the first memory 81;

A prediction address recorder 85, used to record and output the address provided by the scanner 84.

Accordingly, the information processing method using the information processing system 8 is as follows:

Step A: the processor 80 sends the address;

Step B: the matching unit 83 receives the address sent by the processor 80; if the received address matches one of the addresses stored in the matching unit 83, the second memory 82 outputs information block based on the address; if the received address does not match any of the addresses stored in the matching unit 83, the first memory 81 outputs the information block to the second memory 82 based on the address, and the second memory 82 stores and outputs the information block to the processor 80;

Step C: the scanner 84 generates the address based on the information block currently outputted from the first memory 81 and provides the address; and the prediction address recorder 85 stores the address provided by the scanner 84;

Step D: when the second memory 82 outputs an information block, the prediction address recorder 85 outputs the address of another information block which is associated with the information block; if the address is not in the matching unit 83, the address is provided for the first memory 81, and the first memory 81 outputs the information block based on the address.

The difference between the embodiment 6 and the embodiment 5 is that the address outputted by the scanner 84 is not sent directly to the first memory 81 (including sending the address to the first memory 81 via a matching unit 83), whereas the provided address is first stored in the prediction address recorder 85. When the second memory 82 outputs an information block, the prediction address recorder 85 provides the address of the information block associated with the information block for the matching unit 83. If the address is not in the matching unit 83, the address is provided for the first memory 81, and the first memory 81 outputs the information block based on the address.

In the present embodiment 6, there are three branch instructions including the first branch instruction, the second branch instruction and the third branch instruction. The first branch instruction is the current instruction. The second branch instruction is the target instruction of the first branch instruction. The third instruction is the target instruction of the second branch instruction. As used herein, each target instruction is set as a branch instruction. In the present embodiment 6, after the scanner 84 obtains the address of the second branch instruction and the address of the third branch instruction, the scanner 84 does not directly provide the address of the second branch instruction and the address of the third branch instruction for the first memory 81 (including sending the address to the first memory 81 via a matching unit 83). Instead, after the second memory 82 outputs the information block containing the first branch instruction, the prediction addresses recorder 85 provides the second branch instruction address for the matching unit 83. If the matching unit 83 does not contain the address, the address is provided for the first memory 81, and the first memory 81 outputs the information block (i.e., the information block containing the second branch instruction) based on the address information. After the second memory 82 outputs the information block containing the second branch instruction, the prediction addresses recorder 85 provides the third branch instruction address for the matching unit 83. If the matching unit 83 does not contain the address, the address is provided for the first memory 81, and the first memory 81 outputs the information block (i.e., the information block containing the third branch instruction) based on the address information. The probability that the information block outputted by the first memory 81 is selected by the processor 80 is increased, that is, the speed for sending the valid block (the information blocks corresponding to the effective addresses) by the memory can be improved. Further, the speed for obtaining the valid information block by the processor 80 is improved, and the execution speed of the processor 80 is improved.

### Embodiment 7

Referring to FIG. 9, FIG. 9 illustrates a block schematic structural diagram of the information processing system consistent with the disclosed embodiment 7. As shown in FIG. 9, the information processing system 9 includes:

A processor 90, used to obtain information;

A first memory 91, used to store the information and output information block based on a received address;

A second memory 92, used to store the information and output information block based on a received address;

A matching unit 93, used to record addresses of the information blocks stored in the second memory 92;

A scanner 94, used to generate an address based on the current information block and provide the address, and the current information block is the information block currently sent from the first memory 91;

A prediction address recorder 95, used to record and output the address that is provided by the scanner 94 and is not recorded in the matching unit 93.

Accordingly, the information processing method using the information processing system 9 is as follows:

Step A: the processor 90 sends the address;

Step B: the matching unit 93 receives the address sent by the processor 90; if the received address matches one of the addresses stored in the matching unit 93, the second memory 92 outputs information block based on the address; if the received address does not match any of the addresses stored in the matching unit 93, the first memory 91 outputs the information block to the second memory 92 based on the address, and the second memory 92 stores and outputs the information block to the processor 90;

Step C: the scanner 94 generates the address based on the information block currently outputted from the first memory 91 and provides the address; if the matching unit 93 does not contain the address provided by the scanner 94, the prediction address recorder 95 stores the address provided by the scanner 94;

Step D: when the second memory 92 outputs an information block, the prediction address recorder 95 outputs the address of the information block which is associated with the information block; the first memory 91 outputs the information block based on the address.

The difference between the embodiment 7 and the embodiment 6 is that the address recorded by the prediction recorder 95 is the address that is provided by the scanner 94 and is not recorded in the matching unit 93. Thus, the number of the addresses recorded by the prediction address recorder 95 is reduced, reducing the capacity of the prediction address recorder 95.

In the present embodiment 7, when the second memory 92 outputs an information block, the prediction address recorder 95 outputs the address of the information block which is associated with the information block outputted by the second memory 92, then the associated information block is transmitted from the first memory 91 to the second memory 92. When the processor 90 needs to obtain the associated information block, the address of the associated information block is sent to the matching unit 93; then the associated information block is sent from the second memory 92 to the processor 90. That is, the information block which is probably needed by the processor 90 is pre-stored in the second memory 92. Further, the speed for obtaining the associated information block by the processor 90 is improved, and the execution speed of the processor 90 is improved.

### Embodiment 8

Referring to FIG. 10, FIG. 10 illustrates a block schematic structural diagram of the information processing system consistent with the disclosed embodiment 8. AS shown in FIG. 10, the information processing system 10 includes:

A processor 100, used to obtain information;

A first memory 101, used to store the information and output information block based on a received address;

A second memory 102, used to store the information and output information block based on a received address;

A matching unit 103, used to record addresses of the information blocks stored in the second memory 102;

An instruction type information recorder 104, used to record and output the instruction type information of the current information block, and the instruction type information indicates whether an instruction is a branch instruction or a non-branch instruction;

A scanner 105, used to determine whether the address is a branch instruction address based on the information recorded in the instruction type information recorder 104 before an address is generated based on the current information block outputted by the second memory 102; if the address is a branch instruction address, an address is generated based on the current information block.

Accordingly, the information processing method using the information processing system 10 is as follows:

Step A: the processor 100 sends the address;

Step B: the matching unit 103 receives the address sent by the processor 100; if the received address matches one of the addresses stored in the matching unit 103, the second memory 102 outputs information block based on the address; if the received address does not match any of the addresses stored in the matching unit 103, the first memory 101 outputs the information block to the second memory 102 based on the address, and the second memory 102 stores and outputs the information block to the processor 100; wherein the instruction type information recorder 104 obtains the instruction type information of the information block outputted from the first memory 101 to the second memory 102;

Step C: the scanner 105 determines whether the address is a branch instruction address based on the information recorded in the instruction type information recorder 104 before an address is generated based on the current information block outputted by the second memory 102; if the address is a branch instruction address, an address is generated based on the current information block and the address is provided to the first memory 101 by the matching unit 103;

Step D: when the address provided by the scanner 105 is not in the matching unit 103, the first memory 101 outputs the information block based on the address.

Specifically, the instruction type information recorder 104 through a pre-scanner 106 obtains whether the instruction included in the information block outputted by the first memory 101 is a branch instruction or a non-branch instruction. When the processor 100 requests the information block from the memory, it also sends the information about whether the requested information block is a data block or an instruction block. Referring to the embodiment 1, if the information block is an instruction block, the pre-scanner 106 obtains one or more instructions included in the instruction block 101 and determines whether the instruction is a branch instruction or a non-branch based on the instruction type information (OP). The result is then sent to and recorded in the instruction type information recorder 104

When the second memory 102 outputs the information block, before the scanner 105 generates an address based on the information block, the scanner 105 determines whether the instruction is a branch instruction or a non-branch instruction based on the information recorded in the instruction type information recorder 104. If the instruction is a branch instruction, an address is generated.

Thus, the validity of the generated address in the scanner 105 (i.e., the address is highly probably to be requested by the processor) is ensured. That is, the speed for sending the valid block (the information block corresponding to the effective address) by the memory can be improved. Further, the speed for obtaining the valid information block by the processor 100 is improved, and the execution speed of the processor 100 is improved.

In this case, it should be noted that the pre-scanner can be implemented by the implementation of the scanner shown in FIG. 3c, only using a decoding function of the scanner as shown in FIG. 3c. The scanner mentioned in the present embodiment 8 may not have the function of the pre-scanner.

### Embodiment 9

Referring to FIG. 11, FIG. 11 illustrates a block schematic structural diagram of the information processing system consistent with the disclosed embodiment 9. As shown in FIG. 11, the information processing system 11 includes:

A processor 110, used to obtain information;

A first memory 111, used to store the information and output information block based on a received address;

A second memory 112, used to store the information and output information block based on a received address;

A matching unit 113, used to record addresses of the information blocks stored in the second memory 112;

A first scanner 114, used to generate an address based on the current information block and provide the address, and the current information block is the information block currently sent from the first memory 111;

An instruction type information recorder 115, used to record and output the instruction type information of the current information block, and the instruction type information indicates whether an instruction is a branch instruction or a non-branch instruction; for the address recorded in the matching unit 113, the instruction type information recorder 115 serves the instruction corresponding to the address as a non-branch instruction;

A second scanner 116, used to determine whether the address is a branch instruction address based on the information recorded in the instruction type information recorder 115 before an address is generated based on the current information block outputted by the second memory 112; if the address is a branch instruction address, an address is generated based on the current information block.

As used herein, the second scanner 116 may select the same device as the scanner 105 shown in the embodiment 8, i.e., the second scanner 116 may also missing the decoder function.

Accordingly, the information processing method using the information processing system 11 is as follows:

Step A: the processor 110 sends the address;

Step B: the matching unit 113 receives the address sent by the processor 110; if the received address matches one of the addresses stored in the matching unit 113, the second memory 112 outputs information block based on the address; if the received address does not match any of the addresses stored in the matching unit 113, the first memory 111 outputs the information block to the second memory 102 based on the address, and the second memory 112 stores and outputs the information block to the processor 110; wherein the first scanner 114 generates an address based on the current information block outputted by the first memory 111 and provides the address for the first memory 111 by the matching unit 113; at the same time, the first scanner 114 obtains the instruction type information in the information block and provides the instruction type information for the instruction type information recorder 115; the instruction type information recorder 115 records the instruction type information of the information block; for the address recorded in the matching unit 113, the instruction type information recorder 115 serves the instruction corresponding to the address as a non-branch instruction;

Step C: the second scanner 116 determines whether the address is a branch instruction address based on the information recorded in the instruction type information recorder 115 before the second scanner 116 generates an address based on the current information block outputted by the second memory 112; if the address is a branch instruction address, an address is generated based on the current information block and the address is provided for the first memory 111 by the matching unit 113;

Step D: when the address provided by the first scanner 114 or the second scanner 116 is not in the matching unit 113, the first memory 111 outputs the information block based on the address.

One of the differences between the embodiment 9 and the embodiment 8 is that in the present embodiment 9, the instruction type information recorder 115 does not record the branch instruction address stored in the matching unit 113, that is, the branch instruction address stored in the matching unit 113 is served as a non-branch instruction. Thus, when the second scanner 116 generates an address, the address stored in the matching unit 113 is not generated, thereby improving the validity of the address generated by the scanner 116.

Meanwhile, in the present embodiment 9, the first scanner 114 generates the address based on the current information block outputted by the first memory 111. As used herein, the information block that is requested by the processor 110 is transferred to the second memory 112 as soon as possible. Further, the speed for obtaining the valid information block by the processor 110 is improved, and the execution speed of the processor 110 is improved.

### Embodiment 10

Referring to FIG. 12, FIG. 12 illustrates a block schematic structural diagram of the information processing system consistent with the disclosed embodiment 10. As shown in FIG. 12, the information processing system 12 includes:

A processor 120, used to obtain information;

A first memory 121, used to store the information and output information block based on a received address;

A second memory 122, used to store the information and output information block based on a received address;

A first matching unit 123, used to record addresses of the information blocks stored in the second memory 122;

A first scanner 124, used to generate an address based on the current information block outputted by the second memory 122 and provide the address for the first matching unit 123;

A third memory 125, used to store the information and output information block based on a received address;

A second matching unit 126, used to record addresses of the information blocks stored in the third memory 125;

A second scanner 127, used to generate an address based on the current information block outputted by the third memory 125 and provide the address for the second matching unit 126.

Accordingly, the information processing method using the information processing system 12 is as follows:

Step A: the processor 120 sends the address;

Step B: the second matching unit 126 receives the address sent by the processor 120; if the received address matches one of the addresses stored in the second matching unit 126, the third memory 125 outputs information block based on the address; if the address does not match any of the addresses stored in the second matching unit, the address is provided for the first matching unit 123; if the address matches one of the addresses stored in the first matching unit 123, the second memory 122 outputs the information block based on the address; otherwise, the first memory 121 outputs the information block based on the address;

Step C: the first scanner 124 generates an address based on the current information block outputted by the second memory 122 and provides the address for the first matching unit 123; the second scanner 127 generates an address based on the current information block outputted by the third memory 125 and provides the address for the second matching unit 126;

Step D: when the address provided by the first scanner 124 does not match any of the addresses stored in the first matching unit 123, the first memory 121 outputs the information block based on the address; when the address provided by the second scanner 127 does not match any of the addresses stored in the second matching unit 126, the address is provided for the first matching unit 123; if the address does not match any of the addresses stored in the first matching unit 123, the first memory 121 outputs the information block based on the address;

In the present embodiment 10, a multi-level cascade information processing system having a plurality of scanners and a plurality of memory devices is provided. In the information processing system 12, the information block which is probably to be requested by the processor 120 is transferred to the memory that is closer to the processor 120, improving the speed for sending the information block from the memory to the processor. Further, the speed for obtaining the valid information block by the processor 120 is improved, and the execution speed of the processor 120 is improved. Of course, in other embodiments of the present invention, the information processing system may also have more scanners and memory cascade, referring to the content disclosed in the present embodiment 10. The description for the information processing system having more scanners and memory cascade is not repeated in the present application.

### Embodiment 11

Referring to FIG. 13a, FIG. 13a illustrates a block schematic structural diagram of the information processing system consistent with the disclosed embodiment 11. As shown in FIG. 13a, in the present embodiment, the memory system 13a comprises:

A controller 130A, used to control information block output based on an address;

A memory 131A, used to store and output information block;

A first level register 132A, used to store and output information block, wherein the first level register stores multiple pages of information blocks;

A second level register 133A, used to store and output information block, wherein the second level register stores one page of information block;

A scanner 134A, used to generate an address based on the current information block outputted by the second level register and provide the address for the controller;

An address recorder 135A, used to record n most recent times addresses received by the controller, wherein n is a natural number.

In the present embodiment 11, the register (including the first level register 132A and the second level register 133A) is read by the page by page method (wherein ‘page’ is a method to store information).

Memory capacity of the memory 131A, the first level register 132A and the second level register 133A is in turn decreased, whereas the output speed is in turn increased. In particular, the information stored in the second level register 133A is usually the information block corresponding to the address received by the controller 130A, i.e., the information stored in the second level register 133A is usually the information block requested by an external device (such as a processor); and the first level register 132A stores multiple pages of information, including the information outputted by the memory 131A based on the address provided by the scanner.

Specifically, the memory system 13A outputs the stored information block by the following methods:

The controller 130A and the address recorder 135A receive the address, wherein the controller 130A controls the memory 131A, the first level register 132A and the second level registers 133A based on the received address; the address recorder 135A records the received address;

The memory 131A outputs the information block to the first level register 132A based on the control operation of the controller 130A; the first level register 132A outputs the information block to the second level register 133A based on the control operation of the controller 130A; the second level register 133A outputs the information block based on the control operation of the controller 130A;

The scanner 134A generates an address based on the current information block outputted by the second level register and provides the address for the controller 130A, wherein, before the address is provided for the controller 130A, the address is compared with the addresses recorded in the address recorder 135A. If the addresses recorded in the address recorder 135A contain the address, the address is provided for the controller 130A.

Thus, the memory system 13A in the present embodiment 11 may output a plurality of the information blocks based on an address provided by the external device, thereby increasing the speed for obtaining the information blocks by the external device.

Further, in the present embodiment 11, another memory system 13B is also provided. Referring to FIG. 13b, in this implementation, the number of the scanner 134B is two, and the scanner generates an address based on the information block currently outputted by the memory 131B. Because the memory 131B usually outputs more information at the same time, the scanner 134B may also generate more addresses. Therefore, the speed that the memory system 13B outputs information block based on an address provided by the external device is increased. Further, the speed for obtaining the information blocks by the external device is increased. The undisclosed content in the memory system 13B may refer to the memory system 13A. The description is not repeated in the present application.

Without departing from the spirit and principles of the present invention, any modifications, equivalent replacements, and improvements, etc., should be included in the protection scope of the present invention. Therefore, the scope of the present disclosure should be defined by the attached claims.

### INDUSTRIAL APPLICABILITY

The disclosed systems and methods may be used in various applications in memory devices, processors, processor subsystems, and other computing systems. For example, the disclosed systems and methods may be used to provide high performance processor applications, and high-efficient data processing applications.

### SEQUENCE LISTING FREE TEXT

Sequence List Text

1. An information processing system, comprising:
a processor used to obtain information;
a memory used to store the information and output an information block based on a received address; and
a scanner used to generate an address based on the current information block and to provide the address to the memory, the current information block being the information block currently outputted from the memory.

2. The information processing system according to claim 1, wherein, to generate the address, the scanner is configured to:
parse the current information block;
when the current information block includes a branch instruction, calculate a target address of the branch instruction; and
generate the address as the target address of the branch instruction.

3. The information processing system according to claim 2, wherein the scanner filters the generated address, the address provided for the memory is the filtered address, and the scanner filters the generated address by:
judging whether the information block pointed to by the generated address is the current information block; and
when the information block pointed to by the generated address is not the current information block, passing the generated address through filtering.

4. The information processing system according to claim 2, wherein, wherein, to generate the address, the scanner is further configured to:
obtain an address of the current information block address;
add an offset to the current information block address to obtain an offset address; and
generate the address as the offset address.

5. The information processing system according to claim 4, wherein the scanner filters the generated address, the address provided for the memory is the filtered address, and the scanner filters the generated address by:
treating the offset address as the filtered address;
determining whether the information block pointed to by the branch address is the current information block or the information block pointed to by the offset address; and
when the information block pointed to by the branch address is not the current information block or the information block pointed to by the offset address, passing the branch address through filtering.

6. The information processing system according to claim 1, wherein:
the scanner obtains type information of the current information block, and the type information indicates whether the information block is an instruction block or a data block.

7. The information processing system according to claim 6, wherein:
the processor sends a request to the memory requesting an information block, and also sends the type information of the information block to the scanner.

8. The information processing system according to claim 7, wherein:
the memory outputs information block and the address of the information block at the same time.

9. The information processing system according to claim 8, further comprising:
a first address recorder is used to record n most recent times addresses outputted by the processor, wherein n is a natural number.

10. The information processing system according to claim 9, wherein:
the scanner judges whether an address is recorded in the first address recorder before the scanner provides the address for the memory; if not, the address is provided for the memory.

11. The information processing system according to claim 9, wherein:
the scanner obtains the step length of the address based on the address provided for the memory and the address recorded in the first address recorder; and
the scanner adds the step length of the address to the address provided for the memory to generate an address.

12. The information processing system according to claim 9, further comprising:
a second address recorder is used to record m information block addresses stored in the processor, wherein m is a natural number.

13. The information processing system according to claim 19, further including:
a plurality of memory including a first memory and a second memory; and
a plurality of scanners,
wherein a memory and a scanner make up one level;
the plurality of memory and the plurality of scanners make up multiple levels in cascade.

14. The information processing system according to claim 13, further including:
a matching unit used to record addresses of the information blocks stored in the second memory.

15. The information processing system according to claim 14, wherein:
the information block outputted by the first memory is stored in the second memory and sent to the processor; and
the second memory indicates whether the stored information block needs to be stored continuously by tag bits.

16. The information processing system according to claim 15, wherein:
when the second memory stores the information block by a way set, different weights of the tag bits are set to indicate whether the information block corresponding to the tag bit needs to be stored continuously;
when the subsequent information block is being stored in the second memory, the information block is stored in an address corresponding to the information block that does not need to be stored.

17. The information processing system according to claim 15, wherein:
when the second memory stores the information block by fully associative ways, a pointer pointes to the address corresponding to the information block that does not need to be stored;
when the subsequent information block is stored in the second memory, the information block is stored in the address pointed to by the pointer.

18. The information processing system according to claim 15, wherein:
the scanner generates the address based on the current information block outputted by the second memory;
the scanner determines whether an address is recorded in the matching unit before the scanner provides the address for the memory; if not, the address is provided for the first memory.

19. The information processing system according to claim 15, further comprising:
a first address recorder is used to record n most recent times addresses outputted by the processor, wherein n is a natural number;
the number of the scanner is one; the scanner generates an address based on the information block outputted by the second memory;
before the scanner provides the address for the memory, the scanner determines whether the address is recorded in the first address recorder; if not, the address is provided for the first memory.

20. The information processing system according to claim 15, wherein:
the scanner generates the address based on the current information block outputted by the first memory;
the scanner determines whether the address is recorded in the matching unit before the scanner provides an address for the memory; if not, the address is provided for the first memory.

21. The information processing system according to claim 15, further comprising:
a prediction address recorder is used to record and output the address provided for the memory by the scanner.

22. The information processing system according to claim 21, wherein:
the scanner generates the address based on the current information block outputted by the first memory;
the scanner provides the address for the memory by the prediction address recorder;
when the second memory outputs an information block, the prediction address recorder outputs the address of another information block which is associated with the information block.

23. The information processing system according to claim 21, wherein:
the scanner generates the address based on the current information block outputted by the first memory;
the scanner provides the address for the memory by the prediction address recorder;
the address recorded by the prediction address recorder is the address provided for the memory by the scanner and is not recorded in the matching unit;
when the second memory outputs an information block, the prediction address recorder outputs the address of another information block which is associated with the information block.

24. The information processing system according to claim 15, further comprising:
an instruction type information recorder is used to record and output the instruction type information of the current information block, and the instruction type information indicates whether an instruction is a branch instruction or a non-branch instruction.

25. The information processing system according to claim 24, wherein:
the scanner generates the address based on the current information block outputted by the second memory;
the instruction type information recorder records the instruction type information of the current information block outputted by the first memory;
the scanner determines whether the address is a branch instruction address based on the information recorded in the instruction type information recorder before an address is generated based on the current information block;
if the address is a branch instruction address, an address is generated based on the current information block.

26. An information processing method for an information processing system including at least a processor, a memory, and a scanner, the method comprising:
sending, by the processor, an address;
outputting, by the memory, an information block based on the address sent from the processor;
generating, by the scanner, an address based on the current information block outputted from the memory;
providing, by the scanner, the generated address to the memory; and
outputting, by the memory, the information block based on the address provided by the scanner.

27. The information processing method according to claim 26, wherein generating the address further includes:
parsing, by the scanner, the current information block;
when the current information block includes a branch instruction, calculating, by the scanner, a target address of the branch instruction; and
generating the address as the target address of the branch instruction.

28. The information processing method according to claim 27, wherein the scanner filters the generated address, the address provided for the memory is the filtered address, and the scanner filters the generated address by:
judging whether the information block pointed to by the generated address is the current information block; and
when the information block pointed to by the generated address is not the current information block, passing the generated address through filtering.

29. The information processing method according to claim 27, wherein generating the address further includes:
obtaining an address of the current information block address;
adding an offset to the current information block address to obtain an offset address; and
generating the address as the offset address.

30. The information processing method according to claim 29, wherein the scanner filters the generated address, the address provided for the memory is the filtered address, and the scanner filters the generated address by:
treating the offset address as the filtered address;
determining whether the information block pointed to by the branch address is the current information block or the information block pointed to by the offset address; and
when the information block pointed to by the branch address is not the current information block or the information block pointed to by the offset address, passing the branch address through filtering.
